(19) United States
(12) Patent Application Publication
(10) Pub. No.: US 2004/0226581 A1
(43) Pub. Date: Nov. 18, 2004

(54) Method of removing solid waste from home dry cleaning system

(75) Inventors: Robb Richard Gardner, Cincinnati, OH (US); William Michael Scheper, Guilford, IN (US); Richard Timothy Hartshorn, Lawrenceburg, IN (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/876,049

(22) Filed: Jun. 24, 2004

Related U.S. Application Data
(63) Continuation-in-part of application No. 10/738,551, filed on Dec. 17, 2003.
Application No. 10/738,551 is a continuation of application No. 09/849,893, filed on May 4, 2001, now Pat. No. 6,691,536.
(60) Provisional application No. 60/483,348, filed on Jun. 27, 2003.
(60) Provisional application No. 60/209,468, filed on Jun. 5, 2000.

(51) Int. Cl. B08B 9/20

(52) U.S. Cl. 134/25.1

(57) ABSTRACT

The present invention relates to a method of removing lint from a home dry cleaning system.

### CROSS-REFERENCES

The present application claims priority under 35 U.S.C. § 119(e) to U.S. provisional application No. 60/483,348, filed Jun. 27, 2003; and is a continuation-in-part of copending U.S. application Ser. No. 10/738,551, filed on Dec. 17, 2003, which is a continuation of U.S. application Ser. No. 09/849,893, filed on May 4, 2001, now U.S. Pat. No. 6,691,536; which claims the benefit of U.S. Provisional Application Ser. No. 60/209,468 filed on Jun. 5, 2000.

### FIELD OF INVENTION

The present invention relates to a method of removing solid wastes (e.g., lint) from a home dry cleaning system.

### BACKGROUND OF THE INVENTION

A non-aqueous solvent based washing system utilizing lipophilic fluid, such as cyclic siloxanes (especially cyclopentasiloxanes, sometimes termed “D5”), particularly for use with washing machines for in-home use, has recently been developed. Such a system is particularly desired for cleaning textile articles without causing damage associated with wet-washing, like shrinkage and dye transfer.

A particular challenge regarding the use of such systems in the home is to minimize or eliminate the contact of the solvents, surfactants, and cleaning adjuncts by the user. Therefore, it is desirable that such systems be designed to eliminate user exposure to solvents, surfactants, and cleaning adjuncts.

Additionally, running such a system would generate solid wastes (e.g., lint, fibers or particulate soils collected from the wash or drying cycle) which may still contain some solvent, surfactant or cleaning adjuncts. Thus, the disposal of such solid wastes also needs to be done in ways that minimize or eliminate contact between the user and such solid wastes.

### SUMMARY OF THE INVENTION

A method of disposing of wastes from a home dry cleaning system comprising: running a cycle of the home dry cleaning system; collecting wastes from the cycle; and disposing of the wastes.

### BRIEF DESCRIPTION OF THE DRAWINGS

FIG. 1 is a schematic view of a home dry cleaning system for use in the present invention;

FIG. 2 is a cut away side view of a home dry cleaning system for use in the present invention.

### DETAILED DESCRIPTION OF THE INVENTION

The term “fabric article” used herein is intended to mean any article that is customarily cleaned in a conventional laundry process or in a dry cleaning process. As such the term encompasses articles of clothing, linen, drapery, and clothing accessories. The term also encompasses other items made in whole or in part of fabric, such as tote bags, furniture covers, tarpaulins and the like.

The term “lipophilic fluid” used herein is intended to mean any nonaqueous fluid capable of removing sebum, as described in more detail herein below.

The term “processing aid” refers to any material that renders the consumable detergent composition more suitable for formulation, stability, and/or dilution with a lipophilic fluid to form a cleaning composition useful for the present invention process.

The term “mixing” as used herein means combining two or more materials (i.e., fluids, more specifically a lipophilic fluid and a consumable detergent composition) in such a way that a homogeneous mixture is formed. Suitable mixing processes are known in the art. Nonlimiting examples of suitable mixing processes include vortex mixing processes and static mixing processes.

“Down the drain”, as used herein, means both the conventional in-home disposal of materials into the municipal water waste removal systems such as by sewer systems or via site specific systems such as septic systems, as well as for commercial applications the removal to on-site water treatment systems or some other centralized containment means for collecting contaminated water from the facility.

“Solid waste” as used herein, means materials resulting form a cycle of the home dry cleaning system such as lint, fabric fibers and large particulate soil which are not a fabric article or liquid waste.

Incorporated and included herein, as if expressly written herein, are all ranges of numbers when written in a “from X to Y” or “from about X to about Y” format. It should be understood that every limit given throughout this specification will include every lower, or higher limit, as the case may be, as if such lower or higher limit was expressly written herein. Every range given throughout this specification will include every narrower range that falls within such broader range, as if such narrower ranges were all expressly written herein.

Home Dry Cleaning System

The home dry cleaning system comprises a chamber capable of receiving a fabric article, home dry cleaning materials that can be added to the chamber, and a means to remove the home dry cleaning materials from the chamber. Suitable examples are discussed in WO 01/94675. Other suitable examples are discussed in EP 1 103 646; WO 02/08510; U.S. Pat. No. 5,940,988; U.S. Pat. No. 4,765,161; U.S. Pat. No. 5,652,194; and U.S. Pat. No. 6,346,126.

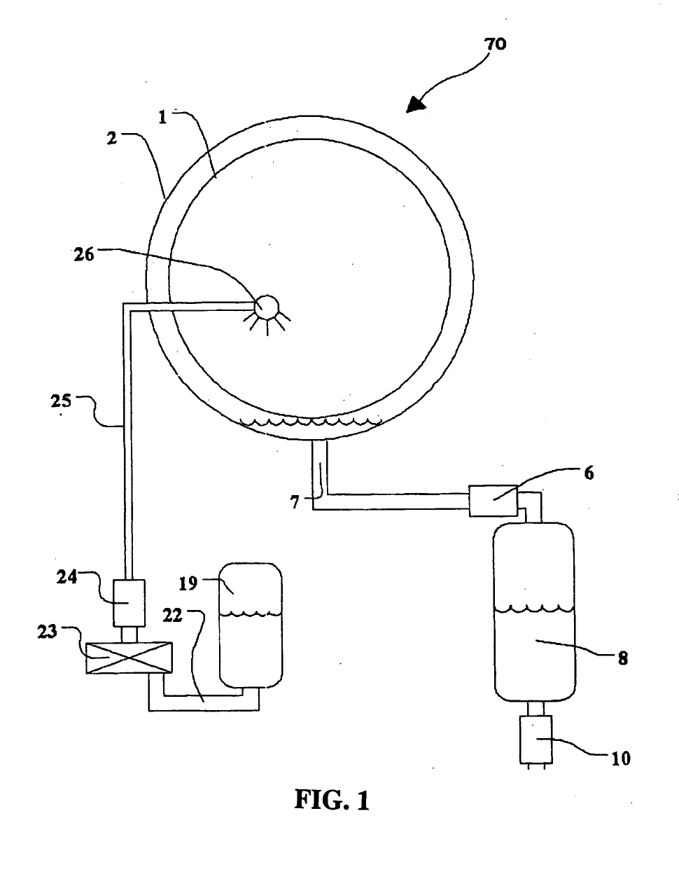

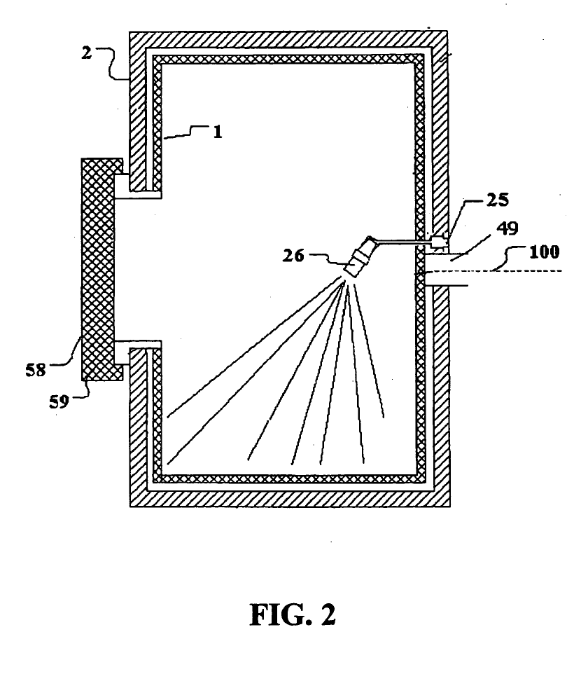

One preferred embodiment of the home dry cleaning system 70 shown in FIG. 1, comprises a fabric-containing chamber 1 capable of receiving a fabric article to be treated and a home dry cleaning material (not shown and discussed hereinbelow), wherein when a fabric article to be treated is present in the fabric-containing chamber 1, and a home dry cleaning material may be introduced into the fabric-containing chamber 1. The home dry cleaning system 70, preferably further comprises an outer chamber 2 capable of receiving the home dry cleaning material from the fabric-containing chamber 1 that is not retained in said fabric-containing chamber 1. The outer chamber 2 preferably houses the fabric-containing chamber 1. The fabric-containing chamber 1 and the outer chamber 2 preferably are of cylindrical construction and have a horizontal access opening 58 and 59, respectively, and, as shown in FIG. 2. The horizontal center line of the outer chamber 2, which is preferably stationary with respect to the fabric-containing chamber 1 coincides with the axis of rotation 100 of the movable fabric-containing chamber 1 movably mounted within the outer chamber 2. The outer chamber 2 preferably comprises an exit port or drain 7 through which the home dry cleaning material received by the outer chamber 2 exits the outer chamber 2. The fabric-containing chamber 1 is preferably rotatably secured to outer chamber 2 by means of drive shaft 49 (FIG. 2). The cross-sectional views of FIG. 2, the outer chamber 2 may have a door 59 having a circular shape with an outer edge, the door 59 is capable of opening and closing and may be used to load and unload fabric articles from the home dry cleaning system 70. The fabric-containing chamber 1 may have an access opening 58 used to load and unload fabric articles from the home dry cleaning system 70; preferably which is concentrically aligned with the outer edge of the door 59 in outer chamber 2. When the home dry cleaning system 70 is in operation, the door 59 is in the closed position, preferably locked by a locking means (not shown) when the home dry cleaning system 70 is in operation.

At least one large storage tank 19 may contain the home dry cleaning material that is delivered to the fabric-containing chamber 1 via an applicator 26, preferably a spray nozzle. The desired home dry cleaning materials are delivered into the applicator 26 preferably by pumping with pump 24. The home dry cleaning material stored in the large storage tank 19 is pumped from through lines 22, first passing through valve 23, then through pump 24, then finally through line 25 to applicator 26.

Once the home dry cleaning material enters the fabric article chamber 1, it is collected in the outer chamber 2. The home dry cleaning material exits the outer chamber 2 by use of a drain 7 and then enters a recover tank 8. Prior to delivering home dry cleaning materials into recovery tank 8, home dry cleaning materials are filtered in filter 6 such that the solid wastes and the liquid wastes in the used home dry cleaning materials (e.g. solvent, surfactants, adjuncts) are collected separately. Preferably an air compressor (not shown) would be connected to the large storage tank 19 by pressure lines. Other means of conveying home dry cleaning materials may include gravity, centrifugal, diaphragm, piston, or peristaltic pumps.

Filter 6 removes solid waste such as lint, fabric fibers and large particulate soil, so they don't settle on the recovery tank 8 bottom and clog downstream lines. Also, filter 6 assures reliable operation of pump 10, since pump 10 is a typically higher pressure pump which generally is of a type more easily damaged by solids.

In one embodiment, an automatic means (not shown) may be operatively associated with the filter 6 such that any solid wastes may be disposed of without the user interacting with the solid waste. The automatic means may be a mechanism that removes solid wastes from the filter 6 and transports them to be disposed of down the drain.

Alternatively, the automatic means may be a mechanism that removes solid wastes from the filter and transports the solid waste to another waste container (not shown), which can then be removed by the user from the home dry cleaning system 70. See US publication 2003/0226214 A1, Radomylselske, et al.

In another embodiment, the automatic means (not shown) may be a system wherein gas or fluid is backflushed through the filter to remove any solid wastes. As used herein “backflushed” means that gas or fluid is forced through the filter in the direction opposite that fluid generally passes from the drain 7 to the recovery tank 8. See U.S. Pat. No. 3,823,823 and U.S. Pat. No. 4,859,218.

In another embodiment, the filter 6 is removably attached to the home dry cleaning system such that after several cycles of the dry cleaning operations, the fitler 6 can be detached and disposed of in a waste container or in domestic trash. A replacement filter 6 can be removably attached to the system. Used filter 6 may also be backflushed, within or removed from the system, to regenerate it. It is desirable that the filter 6 is durable such that it does not need to be removed or regenerated after at least one cycle, preferably after at least two cycles, and more preferably after at least 5 cycles.

The waste container (not shown) may comprise material that is inexpensive, relatively home dry cleaning material repellant, and easily disposable such as plastic bags, plastic containers, coated paper bags, coated paper containers, and any combinations thereof. As used in “relatively home dry cleaning material repellant” means that a home dry cleaning material does not easily penetrate through the container material even upon standing for several hours or days. Preferably, the container material is environmentally friendly and has biodegradable properties.

Home Dry Cleaning Materials

The home dry cleaning material of the present invention may be in any readily dispensable or flowable form, such as, thixotropic gel, shear thinning liquid, liquid, gel, powder, granule, paste, flakes, suspension, microparticles, nanoparticles, and mixtures thereof. Preferably, the home dry cleaning materials of the present invention are selected from the group consisting of at least one solvent, at least one surfactant, at least one additive, and mixtures thereof. Suitable home dry cleaning material include solvent, surfactant, cleaning adjuncts and similar materials.

Solvent

The solvent of the present invention may comprise one or more solvents, preferably being a lipophilic fluid. “Lipophilic fluid” as used herein means any liquid or mixture of liquid that is immiscible with water at up to 20% by weight of water. In general, a suitable lipophilic fluid can be fully liquid at ambient temperature and pressure, can be an easily melted solid, e.g., one that becomes liquid at temperatures in the range from about 0° C. to about 60° C., or can comprise a mixture of liquid and vapor phases at ambient temperatures and pressures, i.e., at 25° C. and 1 atm. pressure.

It is preferred that the lipophilic fluid herein be non-flammable or, have relatively high flash points and/or low VOC characteristics, these terms having conventional meanings as used in the dry cleaning industry, to equal or, preferably, exceed the characteristics of known conventional dry cleaning fluids.

Non-limiting examples of suitable lipophilic fluid materials include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

“Siloxane” as used herein means silicone fluids that are non-polar and insoluble in water or lower alcohols. Linear siloxanes (see for example U.S. Pat. Nos. 5,443,747, and 5,977,040) and cyclic siloxanes are useful herein, including the cyclic siloxanes selected from the group consisting of octamethyl-cyclotetrasiloxane (tetramer), dodecamethyl-cyclohexasiloxane (hexamer), and preferably decamethyl-cyclopentasiloxane (pentamer, commonly referred to as “D5”). A preferred siloxane comprises more than about 50% cyclic siloxane pentamer, more preferably more than about 75% cyclic siloxane pentamer, most preferably at least about 90% of the cyclic siloxane pentamer. Also preferred for use herein are siloxanes that are a mixture of cyclic siloxanes having at least about 90% (preferably at least about 95%) pentamer and less than about 10% (preferably less than about 5%) tetramer and/or hexamer.

The lipophilic fluid can include any fraction of dry-cleaning solvents, especially newer types including fluorinated solvents, or perfluorinated amines. Some perfluorinated amines such as perfluorotributylamines, while unsuitable for use as lipophilic fluid, may be present as one of many possible adjuncts present in the lipophilic fluid-containing composition.

Other suitable lipophilic fluids include, but are not limited to, diol solvent systems e.g., higher diols such as C₆ or C₈ or higher diols, organosilicone solvents including both cyclic and acyclic types, and the like, and mixtures thereof.

Non-limiting examples of low volatility non-fluorinated organic solvents include for example OLEAN® and other polyol esters, or certain relatively nonvolatile biodegradable mid-chain branched petroleum fractions.

Non-limiting examples of glycol ethers include propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether.

Non-limiting examples of other silicone solvents, in addition to the siloxanes, are well known in the literature, see, for example, Kirk Othmer's Encyclopedia of Chemical Technology, and are available from a number of commercial sources, including GE Silicones, Toshiba Silicone, Bayer, and Dow Corning. For example, one suitable silicone solvent is SF-1528 available from GE Silicones.

Non-limiting examples of suitable glycerine derivative solvents for use in the methods and/or apparatuses of the present invention include glyercine derivatives having formula (1):

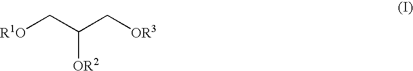

wherein R¹, R² and R³ of formula (I) are each independently selected from: H; branched or linear, substituted or unsubstituted C₁-C₃₀ alkyl, C₂-C₃₀ alkenyl, C₁-C₃₀ alkoxycarbonyl, C₃-C₃₀ alkyleneoxyalkyl, C₁-C₃₀ acyloxy, C₇-C₃₀ alkylenearyl; C₄-C₃₀ cycloalkyl; C₆-C₃₀ aryl; and mixtures thereof. Two or more of R¹, R² and R³ of formula (I) together can form a C₃-C₈ aromatic or non-aromatic, heterocyclic or non-heterocyclic ring.

Non-limiting examples of suitable glycerine derivative solvents include 2,3-bis(1,1-dimethylethoxy)-1-propanol; 2,3-dimethoxy-1-propanol; 3-methoxy-2-cyclopentoxy-1-propanol; 3-methoxy-1-cyclopentoxy-2-propanol; carbonic acid (2-hydroxy-1-methoxymethyl)ethyl ester methyl ester; glycerol carbonate and mixtures thereof.

Non-limiting examples of other environmentally-friendly solvents include lipophilic fluids that have an ozone formation potential of from 0 to about 0.31, lipophilic fluids that have a vapor pressure of from 0 to about 0.1 mm Hg, and/or lipophilic fluids that have a vapor pressure of greater than 0.1 mm Hg, but have an ozone formation potential of from 0 to about 0.31. Non-limiting examples of such lipophilic fluids that have not previously been described above include carbonate solvents (i.e., methyl carbonates, ethyl carbonates, ethylene carbonates, propylene carbonates, glycerine carbonates) and/or succinate solvents (i.e., dimethyl succinates).

“Ozone Reactivity” as used herein is a measure of a VOC's ability to form ozone in the atmosphere. It is measured as grams of ozone formed per gram of volatile organics. A methodology to determine ozone reactivity is discussed further in W. P. L. Carter, “Development of Ozone Reactivity Scales of Volatile Organic Compounds”, Journal of the Air & Waste Management Association, Vol. 44, Page 881-899, 1994. “Vapor Pressure” as used can be measured by techniques defined in Method 310 of the California Air Resources Board.

Preferably, the lipophilic fluid comprises more than 50% by weight of the lipophilic fluid of cyclopentasiloxanes, (“D5”) and/or linear analogs having approximately similar volatility, and optionally complemented by other silicone solvents.

Surfactants

The surfactant suitable for use in the present invention has the general formula (II) and (III):

Yᵤ—(Lₜ—Xᵥ)ₓ—Y′_{w} (II)

L_{y}—(Xᵥ—Yᵤ)ₓ—L′_{z} (III)

and mixtures thereof.

wherein L of formulas (H) and (III) and L′ of formula (IOO) are solvent compatibilizing (or lipophilic) moieties, which are independently selected from:

(a) C₁-C₂₂ alkyl or C₄-C₁₂ alkoxy, linear or branched, cyclic or acyclic, saturated or unsaturated, substituted or unsubstituted;

(b) siloxanes having the formula (IV):

MₐD_{b}D′_{c}D″_{d} (IV)

wherein a of formula (IV) is 0-2; b of formula (IV) is 0-1000; c of formula (IV) is 0-50; d of formula (IV) is 0-50, provided that a+c+d of formula (IV) is at least 1;

M of formula (IV) is R¹₃₋ₑXₑSiO_{1/2} wherein R¹ of formula (IV) is independently H, or an alkyl group, X of formula (IV) is hydroxyl group, and e of formula (IV) is 0 or 1;

D of formula (IV) is R⁴₂SiO_{2/2} wherein R⁴ of formula (IV) is independently H or an alkyl group;

D′ of formula (IV) is R⁵₂SiO_{2/2} wherein R⁵ of formula (IV) is independently H, an alkyl group or (CH₂)_{f}(C₆Q₄)_{g}O—(C₂H₄O)ₕ—(C₃H₆O)ᵢ(CₖH₂ₖ)ⱼ—R³, provided that at least one R⁵ of formula (IV) is (CH₂)_{f}(C₆Q₄)_{g}O—(C₂H₄O)ₕ—(C₃H₆O)ᵢ(CₖH₂ₖ)ⱼ—R³ (hereinafter formula (V)), wherein R³ of formula (V) is independently H, an alkyl group or an alkoxy group, f of formula (V) is 1-10, g of formula (V) is 0 or 1, h of formula (V) is 1-50, i of formula (V) is 0-50, j of formula (V) is 0-50, k of formula (V) is 4-8; C₆Q₄ of formula (V) is unsubstituted or substituted; Q of formula (V) is independently selected from H, C₁₋₁₀ alkyl, C₂₋₁₀ alkenyl, and mixtures thereof; and

D″ of formula (IV) is R⁶₂SiO_{2/2} wherein R⁶ of formula (IV) is independently H, an alkyl group or (CH₂)ₗ(C₆Q₄)ₘ(A)ₙ-[(T)ₒ—(A′)ₚ-]_{q}-(T′)ᵣZ(G)ₛ (hereinafter formula (VI)), wherein 1 is 1-10; m of formula (VI) is 0 or 1; n of formula (VI) is 0-5; o of formula (VI) is 0-3; p of formula (VI) is 0 or 1; q of formula (VI) is 0-10; r of formula (VI) is 0-3; s of formula (VI) is 0-3; C₆Q₄ of formula (VI) is unsubstituted or substituted; Q of formula (VI) is independently selected from H, C₁₋₁₀ alkyl, C₂₋₁₀ alkenyl, and mixtures thereof; A and A′ of formula (VI) are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; T and T′ of formula (VI) are each independently a C₁₋₃₀ straight chained alkyl, C₃₋₃₀ branched alkyl, C₂₋₃₀ alkenyl, or an C₆₋₃₀ aryl which is unsubstituted or substituted; Z of formula (VI) is a hydrogen, carboxylic acid, a hydroxy, a phosphate, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl or C₂₋₃₀ alkenyl, a carbohydrate unsubstituted or substituted with a C₁₋₁₀ alkyl, C₂₋₁o alkenyl, or an ammonium; G of formula (VI) is an anion or cation such as H⁺, Na⁺, Li⁺, K⁺, NH4+, Ca⁺², Mg⁺², Cl⁻, Br⁻, I⁻, mesylate or tosylate; and D″ of formula (IV) may be capped with C₁-C₄ alkyl or hydroxy groups.

Y of formulas (II) and (III) and Y′ of formula (II) are hydrophilic moieties, which are independently selected from hydroxy; polyhydroxy; C₁-C₃ alkoxy; mono- or di-alkanolamine, mono- or di-alkanolamide; C₁-C₄ alkyl substituted alkanolamine; substituted heterocyclic containing O, S, N; sulfates; carboxylate; carbonate; and when Y and/or Y′ of formulas (II) and (III) is ethoxy (EO) or propoxy (PO), it must be capped with a R, which is selected from the group consisting of:

(i) a 4 to 8 membered, substituted or unsubstituted, heterocyclic ring containing from 1 to 3 hetero atoms; and

(ii) linear or branched, saturated or unsaturated, substituted or unsubstituted, cyclic or acyclic, aliphatic or aromatic hydrocarbon radicals having from about 1 to about 30 carbon atoms, as appropriate (i.e., aromatic hydrocarbon radicals having from about 4 to about 30 carbon atoms, preferably from 6 to 30 carbon atoms);

B of formulas (II) and (III) is a bridging linkage selected from 0; S; N; P; C₁ to C₂₂ alkyl, linear or branched, saturated or unsaturated, substituted or unsubstituted, cyclic or acyclic, aliphatic or C₄₋₂₂ aromatic, substituted or unsubstituted, and/or interrupted by O, S, N, P; glycidyl, ester, amido, amino, PO₄²⁻%, HPO₄⁻, PO₃²⁻, HPO₃⁻, which are protonated or unprotonated;

u of formulas (II) and (III) and w of formula (II) are integers independently selected from 0 to 20, provided that in formula (III), u≧1 and in formula (II) u+w≧1;

t of formula (II) is an integer from 1 to 10;

v of formulas (II) and (III) is an integer from 0 to 10;

x of formulas (II) and (III) is an integer from 1 to 20; and

y and z of formula (III) are integers independently selected from 1 to 10.

Nonlimiting examples of surfactants having the above formula include:

(1) alkanolamines;

(2) phophate/phosphonate esters;

(3) gemini surfactants including, but are not limited to, gemini diols, gemini amide alkoxylates, gemini amino alkoxylates;

(4) capped nonionic surfactants;

(5) capped silicone surfactants such as nonionic silicone ethoxylates, silicone amine derivatives;

(6) alkyl alkoxylates;

(7) polyol surfactants; and

(8) mixtures thereof.

Another class of surfactant can include siloxane-based surfactants. The siloxane-based surfactants typically have a weight average molecular weight from 500 to 20,000 daltons. Such materials, derived from poly(dimethylsiloxane), are well known in the art. In the present invention, not all such siloxane-based surfactants are suitable, because they do not provide improved cleaning of soils compared to the level of cleaning provided by the lipophilic fluid itself.

Suitable siloxane-based surfactants comprise a polyether siloxane having the formula (VII):

MₐD_{b}D′_{c}D″_{d}M′₂₋ₐ (VII)

wherein a of formula (VII) is 0-2; b of formula (VII) is 0-1000; c of formula (VII) is 0-50; d of formula (VII) is 0-50, provided that a+c+d of formula (VII) is at least 1;

M of formula (VII) is R¹₃₋ₑXₑSiO_{1/2} wherein R¹ of formula (VII) is independently H, or an alkyl group, X of formula (VII) is hydroxyl group, and e of formula (VII) is 0 or 1.

M′ of formula (VII) is R²₃SiO_{1/2} wherein R² of formula (VII) is independently H, an alkyl group, or (CH₂)_{f}(C₆Q₄)_{g}O—(C₂H₄O)ₕ—(C₃H₆O)ᵢ(CₖH₂ₖ)ⱼ—R³ (hereinafter formula (VII)), provided that at least one R² of formula (VII) is (CH₂)_{f}(C₆Q₄)_{g}O—(C₂H₄O)ₕ—(C₃H₆O)ᵢ(CₖH₂ₖ)ⱼ—R³, wherein R³ of formula (VIII) is independently H, an alkyl group or an alkoxy group, f of formula (VIII) is 1-10, g of formula (VIII) is 0 or 1, h of formula (VIII) is 1-50, i of formula (VIII) is 0-50, j of formula (VIII) is 0-50, k of formula (VIII) is 4-8; C₆Q₄ of formula (VIII) is unsubstituted or substituted; Q of formula (VIII) is independently selected from H, C₁₋₁₀ alkyl, C₂₋₁₀ alkenyl, and mixtures thereof.

D of formula (VII) is R⁴₂SiO_{2/2} wherein R⁴ of formula (VII) is independently H or an alkyl group.

D′ of formula (VII) is R⁵₂SiO_{2/2} wherein R⁵ of formula (VII) is independently R² of formula (VII) provided that at least one R⁵ of formula (VII) is (CH₂)_{f}(C₆Q₄)_{g}O—(C₂H₄O)ₕ—(C₃H₆O)ᵢ(CₖH₂ₖ)ⱼ—R³ (hereinafter formula (IX)), wherein R³ of formula (IX) is independently H, an alkyl group or an alkoxy group, f of formula (IX) is 1-10, g of formula (IX) is 0 or 1, h of formula (IX) is 1-50, i of formula (IX) is 0-50, j of formula (IX) is 0-50, k of formula (IX) is 4-8; C₆Q₄ of formula (IX) is unsubstituted or substituted; Q of formula (IX) is independently selected from H, C₁₋₁₀ alkyl, C₂₋₁₀ alkenyl, and mixtures thereof; and

D″ of formula (VII) is R⁶₂SiO_{2/2} wherein R⁶ of formula (VII) is independently H, an alkyl group or (CH₂)ₗ(C₆Q₄)ₘ(A)ₙ-[(T)ₒ-(A′)ₚ-]_{q}-(T′)ᵣZ(G)ₛ (formula (X)), wherein 1 of formula (X) is 1-10; m of formula (X) is 0 or 1; n of formula (X) is 0-5; o of formula (X) is 0-3; p of formula (X) is 0 or 1; q of formula (X) is 0-10; r of formula (X) is 0-3; s of formula (X) is 0-3; C₆Q₄ of formula (X) is unsubstituted or substituted; Q of formula (X) is independently selected from H, C₁₋₁₀ alkyl, C₂₋₁₀ alkenyl, and mixtures thereof; A and A′ of formula (X) are each independently a linking moiety representing an ester, a keto, an ether, a thio, an amido, an amino, a C₁₋₄ fluoroalkyl, a C₂₋₄ fluoroalkenyl, a branched or straight chained polyalkylene oxide, a phosphate, a sulfonyl, a sulfate, an ammonium, and mixtures thereof; T and T′ of formula (X) are each independently a C₁₋₃₀ straight chained or branched alkyl, a C₂₋₃₀ alkenyl or an C₄₋₃₀ aryl which is unsubstituted or substituted; Z of formula (X) is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl, a C₂₋₃₀ alkenyl, a carbohydrate unsubstituted or substituted with a C₁₋₃₀ alkyl, a C₂₋₃₀ alkenyl, or an ammonium; G of formula (X) is an anion or cation such as H⁺, Na⁺, Li⁺, K⁺, NH₄⁺, Ca⁺², Mg⁺², Cl⁻, Br⁻, I⁻, mesylate or tosylate.

Examples of the types of siloxane-based surfactants described herein above may be found in EP-1,043,443 A1, EP-1,041,189 and WO 01/34,706 (all to GE Silicones) and U.S. Pat. No. 5,676,705, U.S. Pat. No. 5,683,977, U.S. Pat. No. 5,683,473, and EP 1,092,803A1 (all assigned to Lever Brothers).

Nonlimiting commercially available examples of suitable siloxane-based surfactants are TSF 4446 (ex. General Electric Silicones), XS69-B5476 (ex. General Electric Silicones); Jenamine HSX (ex. DelCon) and Y12147 (ex. OSi Specialties).

Yet another preferred class of materials suitable for the surfactant component is organosulfosuccinates. Preferred organosulfosuccinate materials are surfactants with carbon chains of from about 6 to about 20 carbon atoms. Most preferred are organosulfosuccinates containing dialkly chains, each with carbon chains of from about 6 to about 20 carbon atoms. Also preferred are chains containing aryl or alkyl aryl, substituted or unsubstituted, branched or linear, saturated or unsaturated groups. Nonlimiting commercially available examples of suitable organosulfosuccinate surfactants are available under the trade names of AEROSOL OT® and AEROSOL TR-70® (ex. Cytec).

The surfactant component, when present in cleaning compositions, preferably comprises from about 1% to about 99%, more preferably 2% to about 75%, even more preferably from about 5% to about 60% by weight of the composition.

When the cleaning composition is diluted with a lipophilic fluid to prepare the wash liquor, the surfactant preferably comprises from about 0.01% to about 10%, more preferably from about 0.02% to about 5%, even more preferably from about 0.05% to about 2% by weight of the wash liquor.

Polar Solvent

An additional home dry cleaning material may comprise one or more polar solvent. Non-limiting examples of polar solvents include: water, alcohols, glycols, polyglycols, ethers, carbonates, dibasic esters, ketones, other oxygenated solvents, and mixutures thereof. Further examples of alcohols include: C₁-C₃₀ alcohols, such as propanol, ethanol, isopropyl alcohol, and the like, benzyl alcohol, and diols such as 1,2-hexanediol. The DOWANOL® series by Dow Chemical are examples of glycols and polyglycols useful as polar solvents, such as DOWANOL® TPM, TPnP, DPnB, DPnP, TPnB, PPh, DPM, DPMA, DB, and others. Further examples include propylene glycol, butylene glycol, polybutylene glycol and more hydrophobic glycols. Examples of carbonate solvents are ethylene, propylene and butylene carbonantes such as those available under the JEFFSOL® tradename. Polar solvents can be further identified through dispersive (δ_{D}), polar (δ_{P}) and hydrogen bonding (δ_{H}) Hansen solubility parameters. Preferred polar solvents or polar solvent mixtures have fractional polar (δ_{P}) and fractional hydrogen bonding (fH) values of f_{P}>0.02 and f_{H}>0.10, where f_{P}=δ_{P}/(δ_{D}+δ_{P}+δ_{H}) and f_{H}=δ_{H}/(δ_{D}+δ_{P}+δ_{H}), more preferably f_{P}>0.05 and f_{H}>0.20, and most preferably f_{P}>0.07 and f_{H}>0.30.

In a cleaning composition, the levels of polar solvent can be from about 0 wt % to about 70 wt %, preferably about 1 wt % to about 50 wt % even more preferably about 1 wt % to about 30 wt % by weight of the cleaning composition.

When the cleaning composition comprises an amino-functional silicone as the only emulsifying agent, preferred levels of polar solvent are from about 0.01 wt % to about 2 wt %, preferably about 0.05 wt % to about 0.8 wt %, even more preferably about 0.1 wt % to about 0.5 wt % by weight of the cleaning composition.

When the cleaning composition comprises higher levels of polar solvent, the cleaning compositions preferably comprise from about 2 wt % to about 25 wt %, more preferably from about 5 wt % to about 20 wt %, even more preferably from about 8 wt % to about 15 wt % by weight of the cleaning composition.

Cleaning Adjuncts

Another home dry cleaning material for use in connection with the present invention may comprise one or more cleaning adjuncts. Some suitable cleaning adjuncts include, but are not limited to, builders, surfactants, other than those described above, enzymes, bleach activators, bleach catalysts, bleach boosters, bleaches, alkalinity sources, antibacterial agents, colorants, perfumes, pro-perfumes, finishing aids, lime soap dispersants, odor control agents, odor neutralizers, polymeric dye transfer inhibiting agents, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, solvents, process aids, fabric softening agents, optical brighteners, hydrotropes, suds or foam suppressors, suds or foam boosters and mixtures thereof.

Optionally, the hone dry cleaning materials may comprise processing aids. Processing aids facilitate the formation of the cleaning compositions by maintaining the fluidity and/or homogeneity of the cleaning composition, and/or aiding in the dilution process. Processing aids suitable as solvents, preferably solvents other than those described above, include hydrotropes, and/or surfactants, preferably surfactants other than those described above with respect to the surfactant component. Particularly preferred processing aids are protic solvents such as aliphatic alcohols, diols, triols, etc. and nonionic surfactants such as ethoxylated fatty alcohols.

Processing aids, when present in the cleaning compositions, preferably comprise from about 0.02 wt % to about 10 wt %, more preferably from about 0.05 wt % to about 10 wt %, even more preferably from about 0.1 wt % to about 10 wt % by weight of the cleaning composition. Processing aids, when the cleaning composition is diluted with a lipophilic fluid to prepare the wash liquor, preferably comprise from about 1 wt % to about 75 wt %, more preferably from about 5 wt % to about 50 wt % by weight of the wash liquor.

Suitable odor control agents, which may optionally be used as finishing agents, include agents include, cyclodextrins, odor neutralizers, odor blockers and mixtures thereof. Suitable odor neutralizers include aldehydes, flavanoids, metallic salts, water-soluble polymers, zeolites, activated carbon and mixtures thereof.

Perfumes and perfumery ingredients useful comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes may comprise extremely complex mixtures of such ingredients. Pro-perfumes are also useful in the present invention. Such materials are those precursors or mixtures thereof capable of chemically reacting, e.g., by hydrolysis, to release a perfume.

Bleaches, especially oxygen bleaches, are another type of home dry cleaning material suitable as a cleaning adjunct for use in the present invention. This is especially the case for the activated and catalyzed forms with such bleach activators as nonanoyloxybenzenesulfonate and/or any of its linear or branched higher or lower homologs, and/or tetraacetylethylenediamine and/or any of its derivatives or derivatives of phthaloylimidoperoxycaproic acid (PAP; available from Ausimont SpA under trademane EUROCO®) or other imido- or amido-substituted bleach activators including the lactam types, or more generally any mixture of hydrophilic and/or hydrophobic bleach activators (especially acyl derivatives including those of the C₆-C₁₆ substituted oxybenzenesulfonates).

Also suitable are organic or inorganic peracids both including PAP and other than PAP. Suitable organic or inorganic peracids include, but are not limited to: percarboxylic acids and salts; percarbonic acids and salts; perimidic acids and salts; peroxymonosulfuric acids and salts; persulphates such as monopersulfate; peroxyacids such as diperoxydodecandioic acid (DPDA); magnesium peroxyphthalic acid; perlauric acid; perbenzoic and alkylperbenzoic acids; and mixtures thereof.

Detersive enzymes may be utilized as cleaning adjuncts. Proteases, amylases, cellulases, lipases and the like as well as bleach catalysts including the macrocyclic types having manganese or similar transition metals may used at very low, or less commonly, higher levels. Cleaning adjuncts that are catalytic, for example enzymes, can be used in “forward” or “reverse” modes. For example, a lipolase or other hydrolase may be used, optionally in the presence of alcohols as adjuncts, to convert fatty acids to esters, thereby increasing solubility in the lipohilic fluid of the enzyme.

Finishing polymers may also be used as cleaning adjuncts. Nonlimiting examples of finishing polymers that are commercially available are: polyvinylpyrrolidone/dimethylaminoethyl methacrylate copolymer, such as Copolymer 958®, weight average molecular weight of about 100,000 daltons and Copolymer 937, weight average molecular weight of about 1,000,000 daltons, available from GAF Chemicals Corporation; adipic acid/dimethylaminohydroxypropyl diethylenetriamine copolymer, such as CARTARETIN® F-4 and F-23, available from Sandoz Chemicals Corporation; methacryloyl ethyl betaine/methacrylates copolymer, such as DIAFORMER® Z-SM, available from Mitsubishi Chemicals Corporation; polyvinyl alcohol copolymer resin, such as VINEX® 2019, available from Air Products and Chemicals or MOWEO1®, available from Clariant; adipic acid/epoxypropyl diethylenetriamine copolymer, such as DELSETTE® 101, available from Hercules Incorporated; polyamine resins, such as CYPRO® 515, available from Cytec Industries; polyquaternary amine resins, such as KYMENE® 557H, available from Hercules Incorporated; and polyvinylpyrrolidone/acrylic acid, such as SOKALAN EG 310®, available from BASF.

The cleaning adjuncts may also be an antistatic agent. Any suitable well-known antistatic agents used in conventional laundering and dry cleaning are suitable as cleaning adjuncts of the present invention. Especially suitable as antistatic agents are the subset of fabric softeners which are known to provide antistatic benefits. For example those fabric softeners that have a fatty acyl group which has an iodine value of above 20, such as N,N-di(tallowoyl-oxy-ethyl)-N,N-dimethyl ammonium methylsulfate. However, it is to be understood that the term antistatic agent is not to be limited to just this subset of fabric softeners and includes all antistatic agents.

Insect and moth repelling may also be used as cleaning adjuncts. Preferred insect and moth repellent are perfume ingredients, such as citronellol, citronellal, citral, linalool, cedar extract, geranium oil, sandalwood oil, 2-(diethylphenoxy)ethanol, 1-dodecene, etc. Other examples of insect and/or moth repellents are disclosed in U.S. Pat. Nos. 4,449,987; 4,693,890; 4,696,676; 4,933,371; 5,030,660; 5,196,200; and in “Semio Activity of Flavor and Fragrance Molecules on Various Insect Species”, B. D. Mookherjee et al., published in Bioactive Volatile Compounds from Plants, ACS Symposium Series 525, R. Teranishi, R. G. Buttery, and H. Sugisawa, 1993, pp. 35-48.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. All documents cited are, in relevant part, incorporated herein by reference; the citation of any document is not to be construed as an admission that it is prior art with respect to the present invention.

What is claimed is:

1. A method of disposing of wastes from a home dry cleaning system comprising:
a) running a cycle of the home dry cleaning system;
b) collecting wastes from the cycle; and
c) disposing of the wastes.

2. The method of claim 1 wherein the wastes are solid wastes.

3. The method of claim 2 wherein the solid waste is collected separately from the liquid waste.

4. The method of claim 3 wherein the solid waste is disposed after at least one cycle.

5. The method of claim 3 wherein the solid waste is disposed of after at least two cycles.

6. The method of claim 3 wherein the solid waste is disposed of by automatic means.

7. The method of claim 6 wherein the solid waste is disposed such that the user does not come into direct contact with the solid waste.

8. The method of claim 7 wherein the solid waste is disposed of down the drain.

9. The method of claim 7 wherein the solid waste is placed in a container by the automatic means and the container is removed by the user.
